(19) United States
(12) Patent Application Publication
(10) Pub. No.: US 2025/0039926 A1
(43) Pub. Date: Jan. 30, 2025

(54) NON-PRIMARY CHANNEL ACCESS IN WIRELESS NETWORKS

(71) Applicant: NEWRACOM, Inc., Irvine, CA (US)

(72) Inventors: Heejung YU, Daejeon (KR); Joonsoo LEE, Seoul (KR); Si-Chan NOH, Seoul (KR); Il-Gu LEE, Seoul (KR)

(73) Assignee: NEWRACOM, Inc., Irvine, CA (US)

(21) Appl. No.: 18/767,775

(22) Filed: Jul. 9, 2024

Related U.S. Application Data
(60) Provisional application No. 63/515,163, filed on Jul. 24, 2023.

(51) Int. Cl. H04W 74/0808; H04W 84/12

(52) U.S. Cl. CPC H04W 74/0808; H04W 84/12

(57) ABSTRACT

Disclosed herein is a method performed by a station (STA) in a wireless network to access a non-primary channel. The method includes determining a maximum supportable bandwidth of a primary transmission opportunity (TXOP) established in a primary channel, responsive to a determination that the maximum supportable bandwidth of the primary TXOP is smaller than a maximum supportable bandwidth of the STA, establishing a secondary TXOP in the non-primary channel, and transmitting a data frame to a second STA during the secondary TXOP in the non-primary channel.

### CROSS-REFERENCE TO RELATED APPLICATION

This application claims the benefit of U.S. Provisional Application No. 63/515,163, filed Jul. 24, 2023, titled, “Non-Primary Channel Access for Beyond IEEE 802.11be Networks,” which is hereby incorporated by reference.

### TECHNICAL FIELD

The present disclosure generally relates to wireless communications, and more specifically, relates to accessing a non-primary channel in a wireless network.

### BACKGROUND

Institute of Electrical and Electronics Engineers (IEEE) 802.11 is a set of physical and Media Access Control (MAC) specifications for implementing Wireless Local Area Network (WLAN) communications. These specifications provide the basis for wireless network products using the Wi-Fi brand managed and defined by the Wi-Fi Alliance. The specifications define the use of the 2.400-2.500 Gigahertz (GHz) as well as the 4.915-5.825 GHz bands. These spectrum bands are commonly referred to as the 2.4 GHz and 5 GHz bands. Each spectrum is subdivided into channels with a center frequency and bandwidth. The 2.4 GHz band is divided into 14 channels spaced 5 Megahertz (MHz) apart, though some countries regulate the availability of these channels. The 5 GHz band is more heavily regulated than the 2.4 GHz band and the spacing of channels varies across the spectrum with a minimum of a 5 MHz spacing dependent on the regulations of the respective country or territory.

WLAN devices are currently being deployed in diverse environments. These environments are characterized by the existence of many Access Points (APs) and non-AP stations (STAs) in geographically limited areas. Increased interference from neighboring devices gives rise to performance degradation. Additionally, WLAN devices are increasingly required to support a variety of applications such as video, cloud access, and offloading. Video traffic, in particular, is expected to be the dominant type of traffic in WLAN deployments. With the real-time requirements of some of these applications, WLAN users demand improved performance.

With existing wireless networking standards (e.g., IEEE 802.11 802.11a/g/n/ac/ax/be), if the primary 20 Megahertz (MHz) channel is busy, a STA cannot transmit in any portion of the operating bandwidth, even if those portions are idle. For example, if the primary 20 MHz channel is busy, a STA cannot transmit in a non-primary channel, even if the non-primary channel is idle. This may result in the bandwidth being underutilized. The bandwidth underutilization may become more severe as the operating bandwidth increases. For example, the IEEE 802.11be wireless networking standard (also referred to as Extremely High Throughput (EHT)) can support an operating bandwidth of 320 MHz, but a busy 20 MHZ primary channel prevents a STA from accessing the remaining 300 MHz of idle bandwidth.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example wireless local area network (WLAN) with a basic service set (BSS) that includes a plurality of wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates Inter-Frame Space (IFS) relationships, in accordance with some embodiments of the present disclosure.

FIG. 5 illustrates a Carrier Sense Multiple Access/Collision Avoidance (CSMA/CA) based frame transmission procedure, in accordance with some embodiments of the present disclosure.

FIG. 6 shows a table comparing various iterations of Institute of Electrical and Electronics Engineers (IEEE) 802.11 standard, in accordance with some embodiments of the present disclosure.

FIG. 7 shows a table, which describes fields of an Extreme High Throughput (EHT) frame format, in accordance with some embodiments of the present disclosure.

FIG. 8 is a diagram showing an overlapping basic service set (OBSS) scenario in which bandwidth can be inefficiently utilized.

FIG. 9 is a diagram showing a single basic service set (BSS) scenario in which bandwidth can be inefficiently utilized.

FIG. 10 is a diagram showing a non-primary channel access in the OBSS scenario, according to some embodiments.

FIG. 11 is a diagram showing a non-primary channel access in the single BSS scenario, according to some embodiments.

FIG. 12 is a diagram showing a frame exchange sequence for accessing a non-primary channel, according to some embodiments.

FIG. 13 is a flow diagram showing a method for accessing a non-primary channel, according to some embodiments.

### DETAILED DESCRIPTION

One aspect of the present disclosure generally relates to wireless communications, and more specifically, relates to accessing a non-primary channel in a wireless network.

In a basic service set (BSS) served by an access point (AP) supporting a wide operating bandwidth (e.g., an IEEE 802.11be AP supporting an operating bandwidth of 320 Megahertz (MHz)), there can be various STAs supporting varying operating bandwidths. For example, the BSS may include an IEEE 802.11a STA supporting a 20 MHz operating bandwidth, an IEEE 802.11n STA supporting a 40 MHz operating bandwidth, an IEEE 802.11ac STA supporting a 80 MHz bandwidth, an IEEE 802.11ax STA supporting a 160 MHz bandwidth, and/or an IEEE 802.11be STA supporting a 320 MHz bandwidth. An AP and a STA in the BSS may establish a transmission opportunity (TXOP) in a primary channel. The primary channel may be a channel that includes the primary 20 MHz channel (e.g., a 80 MHz channel that includes the primary 20 MHz channel). A non-primary channel may be a channel that does not include the primary 20 MHz channel (e.g., a 80 MHz channel that does not include the primary 20 MHz channel). The maximum supportable bandwidth of the TXOP may be the maximum supportable bandwidth of the STA. The maximum supportable bandwidth of the STA may depend on the version of the wireless networking standard implemented by the STA (e.g., if the STA implements the IEEE 802.11ac wireless networking standard, then its maximum supportable bandwidth may be 80 MHZ). During the TXOP, non-primary channels that are outside of the operating bandwidth of the TXOP go unused (remain idle), which is an inefficient utilization of the available operating bandwidth.

Embodiments allow for more efficient bandwidth utilization by allowing a non-primary channel to be used for other transmissions during a TXOP established in the primary channel. The non-primary channel access may be a peer-to-peer (P2P) transmission between STAs in the same BSS in which the TXOP was established or an overlapping BSS (OBSS) transmission in an OBSS that overlaps the BSS in which the TXOP was established.

According to some embodiments, a STA (which may be an AP STA or a non-AP STA) determines a maximum supportable bandwidth of a primary TXOP established in a primary channel. Responsive to a determination that the maximum supportable bandwidth of the primary TXOP is smaller than a maximum supportable bandwidth of the STA, the STA may establish a secondary TXOP in a non-primary channel. The STA may then transmit a data frame to another STA during the secondary TXOP in the non-primary channel. The secondary TXOP may occur during the middle of the primary TXOP. Thus, the STA may be able to transmit data in the non-primary channel while STAs involved in the primary TXOP transmit data in the primary channel, which results in more efficient bandwidth utilization.

For purposes of illustration, various embodiments are described herein in the context of wireless networks that are based on IEEE 802.11 wireless networking standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

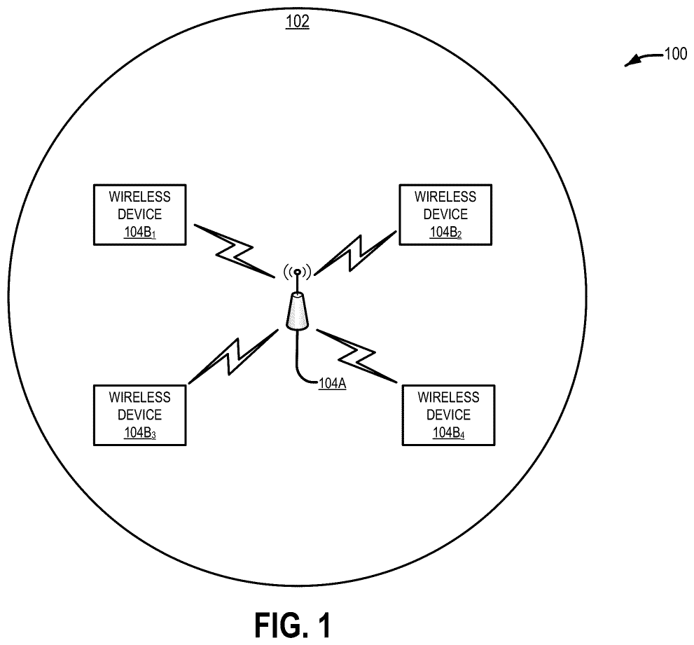

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/bc). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for case of description, only the non-AP STAs may be referred to as STAs, unless the context indicates otherwise. Although shown with four non-AP STAs (e.g., the wireless devices 104B₁-104B₄), the WLAN 100 may include any number of non-AP STAs (e.g., one or more wireless devices 104B).

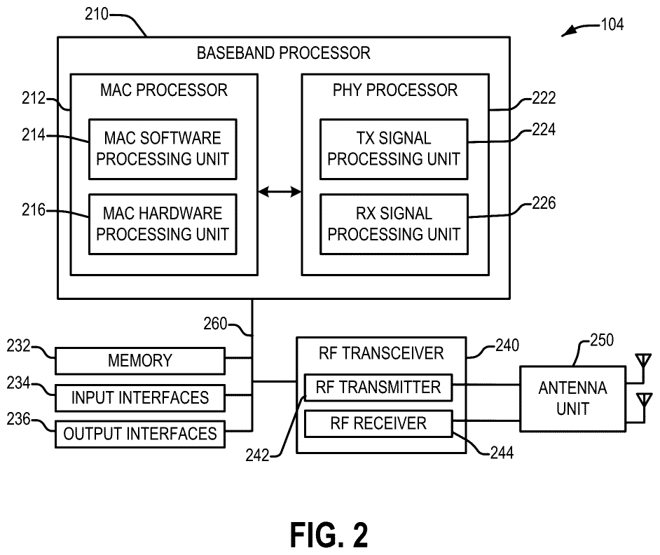

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in cither hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

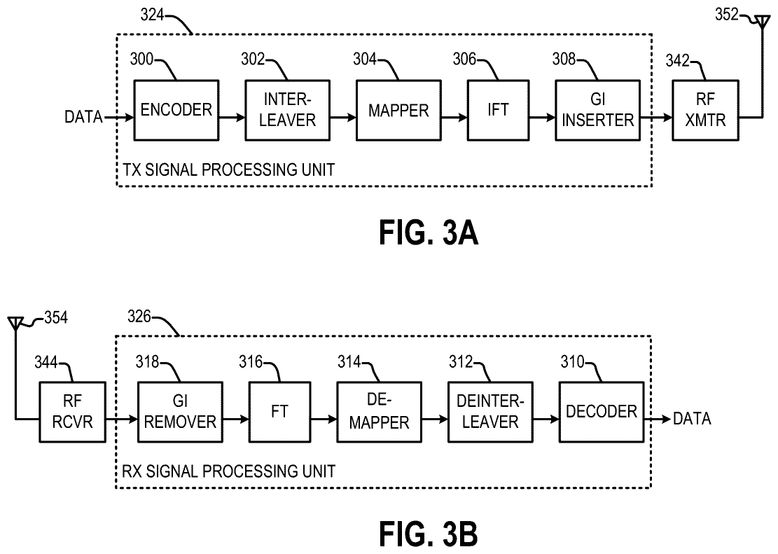

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MH2, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

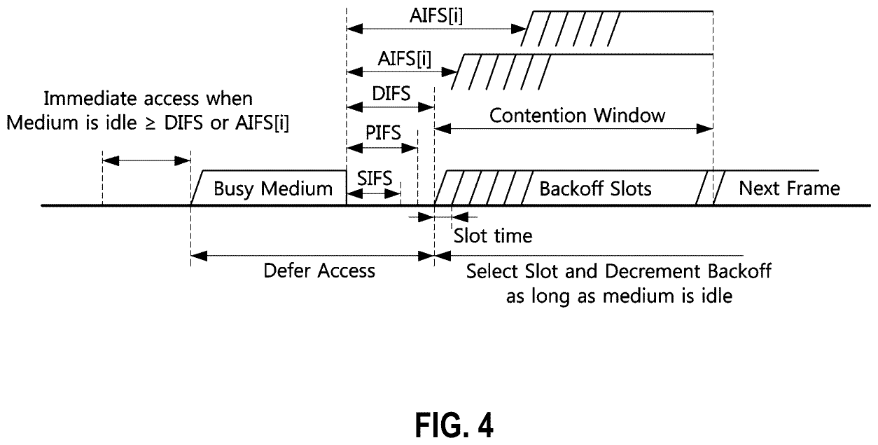

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS [i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS [AC]) has elapsed. When transmitted by the QoS STA, any of the data frame, the management frame, and the control frame, which is not the response frame, may use the AIFS [AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

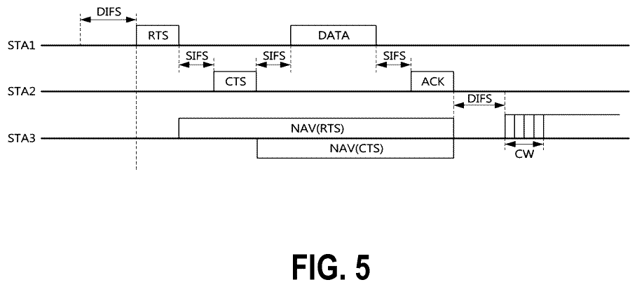

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 docs not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

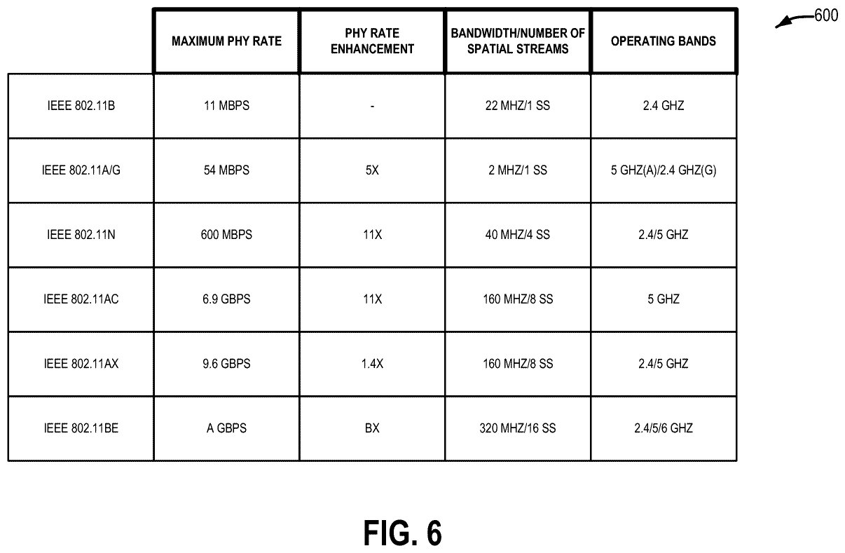

With clear demand for higher peak throughput/capacity in a WLAN, a new working group has been assembled to generate an amendment to IEEE 802.11. This amendment is called IEEE 802.11be (i.e., Extreme High Throughput (EHT)) and was created to support an increase to the peak PHY rate of a corresponding WLAN. Considering IEEE 802.11b through 802.11ac, the peak PHY rate has been increased by 5× to 11× as shown in FIG. 6, which presents a table 600 comparing various iterations of IEEE 802.11. In case of IEEE 802.11ax, the 802.11ax working group focused on improving efficiency, not peak PHY rate in dense environments. The maximum PHY rate (A Gbps) and PHY rate enhancement (Bx) for IEEE 802.11be could rely on the highest MCS (e.g., 4,096 QAM and its code rate).

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHz band (5.925-7.125 GHZ) is being considered for unlicensed use. This would allow APs and STAs to become tri-band devices. Larger than 160 MHz data transmissions (e.g., 320 MHZ) could be considered to increase the maximum PHY rate. For example, 320 MHz or 160+160 MHz data could be transmitted in the 6 GHz band. For example, 160+160 MHz data could be transmitted across the 5 and 6 GHz bands.

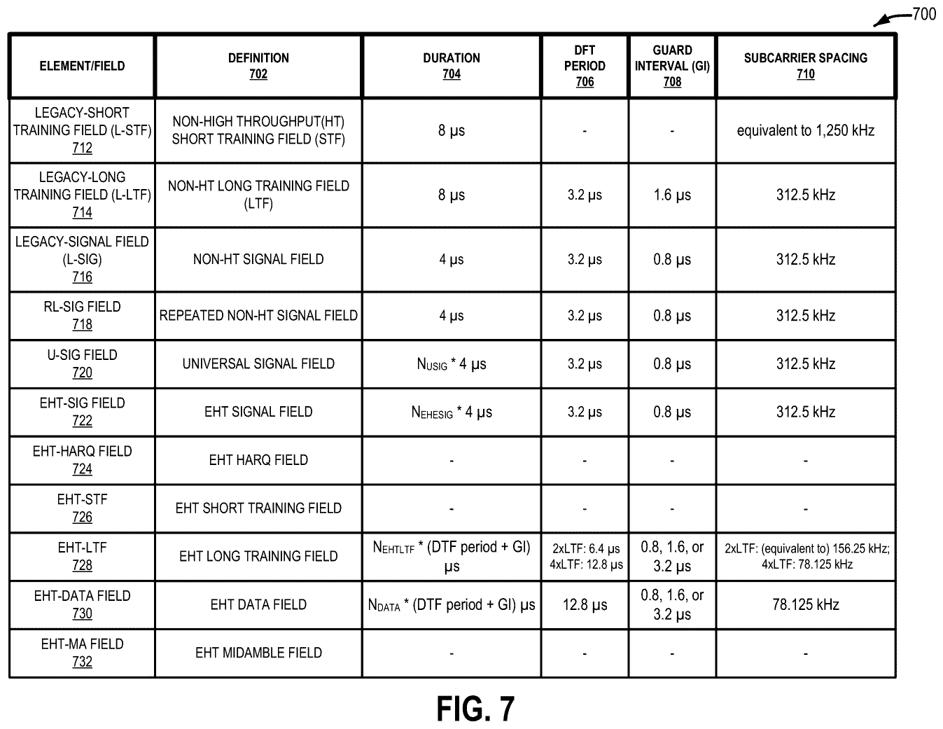

In some embodiments, a transmitting STA generates a PPDU frame and transmits it to a receiving STA. The receiving STA receives, detects, and processes the PPDU. The PPDU can be an EHT PPDU that includes a legacy part (e.g., a legacy short training field (L-STF), a legacy long training field (L-LTF), and a legacy signal (L-SIG) field), an EHT signal A field (EHT-SIG-A), an EHT signal B field (EHT-SIG-B), an EHT hybrid automatic repeat request field (EHT-HARQ), an EHT short training field (EHT-STF), an EHT long training field (EHT-LTF), and an EHT-DATA field. FIG. 7 includes a table 700, which describes fields of an EHT frame format. In particular, table 700 describes various fields that may be within the PHY preamble, data field, and midamble of an EHT frame format. For example, table 700 includes definitions 702, durations 704, Discrete Fourier transform (DFTs) periods 706, guard intervals (GIs) 708, and subcarrier spacings 710 for one or more of a legacy short training field (L-STF) 712, legacy long training field (L-LTF) 714, legacy signal field (L-SIG) 716, repeated L-SIG (RL-SIG) 718, universal signal field (U-SIG) 720, EHT signal field (EHT-SIG) 722, EHT hybrid automatic repeat request field (EHT-HARQ) 724, EHT short training field (EHT-STF) 726, EHT long training field (EHT-LTF) 728, EHT data field 730, and EHT midamble field (EHT-MA) 732.

The distributed nature of a channel access network, such as in IEEE 802.11 wireless networks, makes carrier sensing mechanisms important for collision free operation. The physical carrier sensing mechanism of one STA is responsible for detecting the transmissions of other STAs. However, it may be impossible to detect every single case in some circumstances. For example, one STA which may be a long distance away from another STA may see the medium as idle and begin transmitting a frame while the other STA is also transmitting. To overcome this hidden node, a network allocation vector (NAV) may be used. However, as wireless networks evolve to include simultaneous transmission/reception to/from multiple users within a single basic service set (BSS), such as uplink (UL)/downlink (DL) multi-user (MU) transmissions in a cascading manner, a mechanism may be needed to allow for such a situation. As used herein, a multi-user (MU) transmission refers to cases that multiple frames are transmitted to or from multiple STAs simultaneously using different resources. Examples of different resources are different frequency resources in OFDMA transmissions and different spatial streams in MU-MIMO transmissions. Therefore, DL-OFDMA, DL-MU-MIMO, UL-OFDMA, and UL-MU-MIMO are examples of MU transmissions.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

To improve WLAN systems, AP cooperation has been discussed as a possible technology to be adopted in IEEE 802.11be, where there is high level classification depending on various AP cooperation schemes. For example, there is a first type of cooperation scheme in which data for a user is sent from a single AP (sometimes referred to as “coordinated”) and there is a second type of cooperation scheme in which data for a user is sent from multiple APs (sometimes referred to as “joint”).

For the coordinated scheme, multiple APs are 1) transmitting on the same frequency resource based on coordination and forming spatial nulls to allow for simultaneous transmission from multiple APs or 2) transmitting on orthogonal frequency resources by coordinating and splitting the spectrum to use the spectrum more efficiently. For the joint scheme, multiple APs are transmitting jointly to a given user.

With existing wireless networking standards (e.g., IEEE 802.11 802.11a/g/n/ac/ax/bc), if the primary 20 MHz channel is busy, a STA cannot transmit in any portion of the operating bandwidth, even when those portions are idle. For example, if the primary 20 MHz channel is busy, a STA cannot transmit in a non-primary channel, even if the non-primary channel is idle. This may result in the bandwidth being underutilized. The bandwidth underutilization may become more severe as the operating bandwidth increases. For example, the IEEE 802.11bc wireless networking standard (also referred to as Extremely High Throughput (EHT)) supports an operating bandwidth of 320 MHz, but a busy 20 MHz primary channel prevents a STA from accessing the remaining 300 MHz of idle bandwidth.

Existing wireless networking standards require that all transmissions be made in a channel that includes the primary 20 MHz channel. That is, transmissions in channels not including the primary 20 MHz are not allowed, which can result in inefficient bandwidth utilization, as described below.

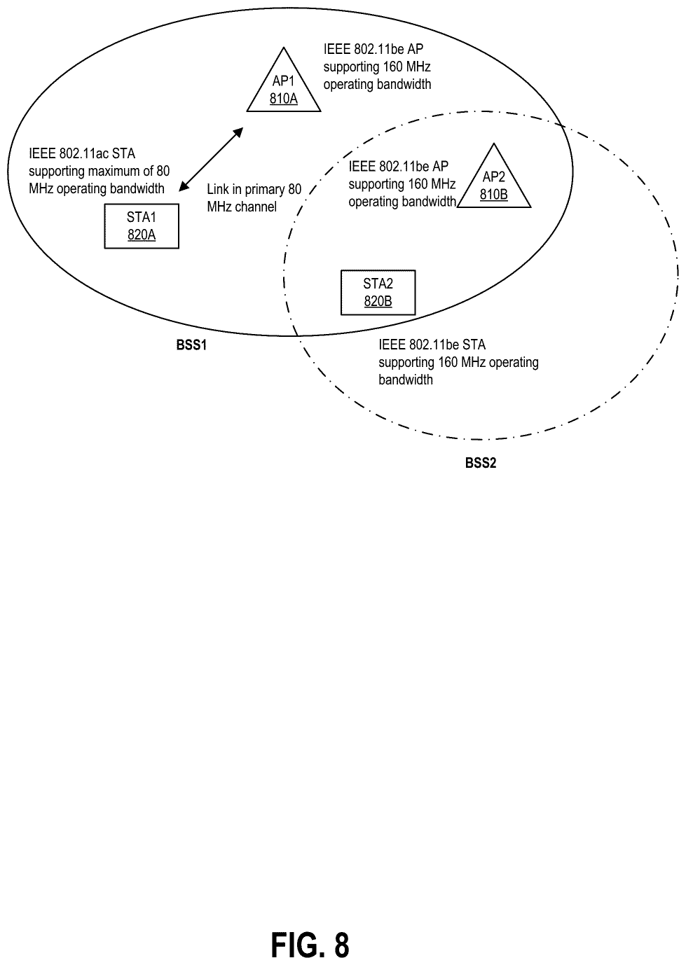

FIG. 8 is a diagram showing an OBSS scenario in which bandwidth can be inefficiently utilized.

As shown in the diagram, AP1 810A may serve BSS1 and AP2 810B may serve BSS2. The coverage areas of BSS1 and BSS2 may overlap. Thus, BSS2 may be considered as an OBSS from the perspective of BSS1 (and vice versa). In this example, it is assumed that BSS1 and BSS2 use the same primary 20 MHz channel. AP1 810A and AP2 810B may be IEEE 802.11bc APs that support a 160 MHz operating bandwidth (in general, IEEE 802.11bc APs can support up to 320 MHz operating bandwidth but some of the examples provided herein assume 160 MHz operation—it should be appreciated that the techniques described herein can be extended to 320 MHz operation). BSS1 may include STA1 820A. STA1 820A may be an IEEE 802.11ac STA that supports a 80 MHz operating bandwidth. AP1 810A and STA1 820A may communicate over a link in the primary 80 MHz channel. The primary 80 MHz channel is an 80 MHz channel that includes the primary 20 MHz channel. BSS2 may include STA2 820B. STA 820B may be an IEEE 802.11be STA that supports a 160 MHz operating bandwidth.

AP1 810A and STA1 820A may establish a TXOP in BSS1 in the primary 80 MHZ channel. The establishment of such a TXOP in BSS1 may cause OBSS APs/STAs in the coverage area of BSS1 such as AP2 810B and STA 820B of BSS2 to set their network allocation vector (NAV) for the duration of the TXOP. As a result, the establishment of the TXOP in BSS1 in the primary 80 MHz channel may prevent AP2 810B and STA2 820B of BSS2 from communicating with each other during the TXOP even though the secondary 80 MHz channel (an 80 MHz channel that does not include the primary 20 MHz channel and does not overlap with the primary 80 MHz channel) is idle.

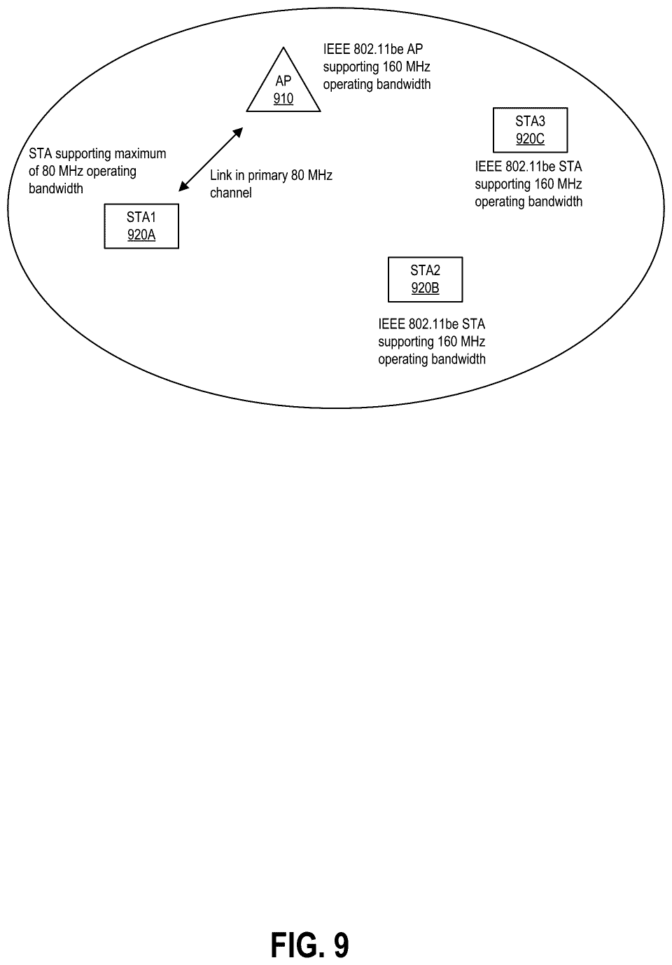

FIG. 9 is a diagram showing a single BSS scenario in which bandwidth can be inefficiently utilized.

As shown in the diagram, AP 910 may serve a BSS. The BSS may include STA1 920A, STA2 920B, and STA3 920C. AP 910 may be an IEEE 802.11be AP that supports a 160 MHz operating bandwidth. STA1 920A may be an IEEE 802.11ac STA that supports a 80 MHz operating bandwidth. STA2 920B and STA3 920C may be IEEE 802.11be STAs that support a 160 MHz operating bandwidth. As shown in the diagram, AP 910 and STA1 920A may communicate over a link in the primary 80 MHz channel. The primary 80 MHz channel is an 80 MHz channel that includes the primary 20 MHz channel.

AP 910 and STA1 920A may establish a TXOP in the BSS in the primary 80 MHZ channel. The establishment of such a TXOP in the BSS may cause other STAs in the BSS such as STA2 920B and STA3 920C to set their NAV for the duration of the TXOP. As a result, the establishment of the TXOP in the primary 80 MHz channel may prevent STA2 920B and STA2 920C from communicating directly with each other (e.g., over a peer-to-peer (P2P) link) during the TXOP even though the secondary 80 MHz channel is idle.

In both of the scenarios shown in FIG. 8 and FIG. 9, certain APs/STAs (e.g., AP2 810B and STA2 820B shown in FIG. 8 and STA2 920B and STA3 920C shown in FIG. 9) support a 160 MHz operating bandwidth. However, if the primary 80 MHz channel is busy, those APs/STAs are not allowed to transmit data in a non-primary channel (e.g., not allowed to transmit in the secondary 80 MHz channel). This is the current operational rule in wireless networking standards (e.g., IEEE 802.11 wireless networking standards).

It is observed that the APs/STAs involved in the TXOP (e.g., AP1 810A and STA1 820A shown in FIG. 8 and AP 910 and STA1 920A shown in FIG. 9) cannot transmit data in the secondary 80 MHz channel during the TXOP because the maximum supportable bandwidth of one of the STAs (e.g., STA1 820A in the scenario shown in FIG. 8 and STA1 920A in the scenario shown in FIG. 9) is 80 MHz. Thus, the secondary 80 MHZ channel may be idle during the TXOP. Embodiments leverage this observation to allow APs/STAs that are not involved in the TXOP (e.g., AP2 810B and/or STA2 820B shown in FIG. 8 and STA2 920B and STA3 920C shown in FIG. 9) to access the idle secondary 80 MHz channel during the TXOP. The secondary 80 MHz channel is an example of a non-primary channel. Although the current operational rule in wireless networking standards is that an AP/STA is not allowed to transmit data in any non-primary channel if the primary channel is busy, future wireless networking standards (e.g., beyond IEEE 802.11be) may relax this restriction and allow APs/STAs to access a non-primary channel even when the primary channel is busy.

In embodiments, if an AP/STA (e.g., AP2 810B and/or STA2 820B shown in FIG. 8 and STA2 920B and STA3 920C shown in FIG. 9) knows that the maximum supportable bandwidth of a particular TXOP (e.g., which may depend on the maximum supportable bandwidths of the APs/STAs involved in the TXOP) is smaller than the maximum supportable bandwidth of the AP/STA, then, it can temporarily use an available non-primary channel for the duration of the particular TXOP. Thus, even though the primary channel is busy during the TXOP, non-primary channel access can be allowed under the Enhanced Distributed Channel Access (EDCA) rule.

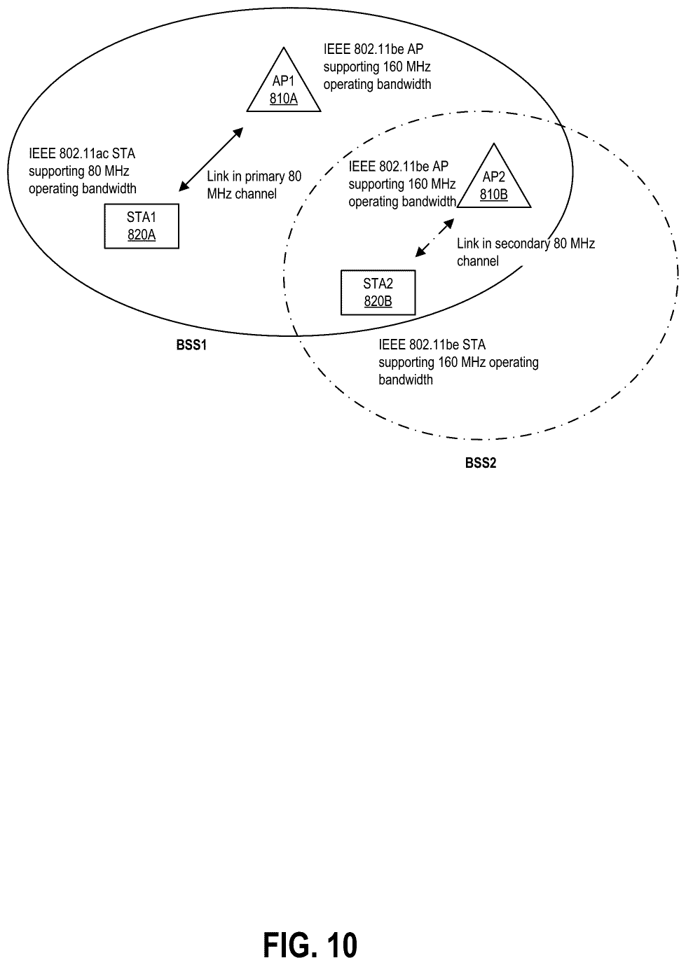

FIG. 10 is a diagram showing a non-primary channel access in the OBSS scenario, according to some embodiments.

The scenario shown in the diagram is similar to the OBSS scenario shown in FIG. 8 and described in relation thereto, but shows that AP2 810B and STA2 1020B of BSS2 may communicate over a link in the secondary 80 MHz channel during the TXOP in BSS1 in the primary 80 MHz channel. In particular, AP2 810B and STA2 820B may recognize that the maximum supportable bandwidth of the TXOP in BSS1 (80 MHZ) is less than its own maximum supportable bandwidth of 160 MHz, which means that there may be idle bandwidth available during the TXOP. Based on such recognition, AP2 810B and STA2 820B may communicate with each other over a link in the secondary 80 MHz channel during the TXOP.

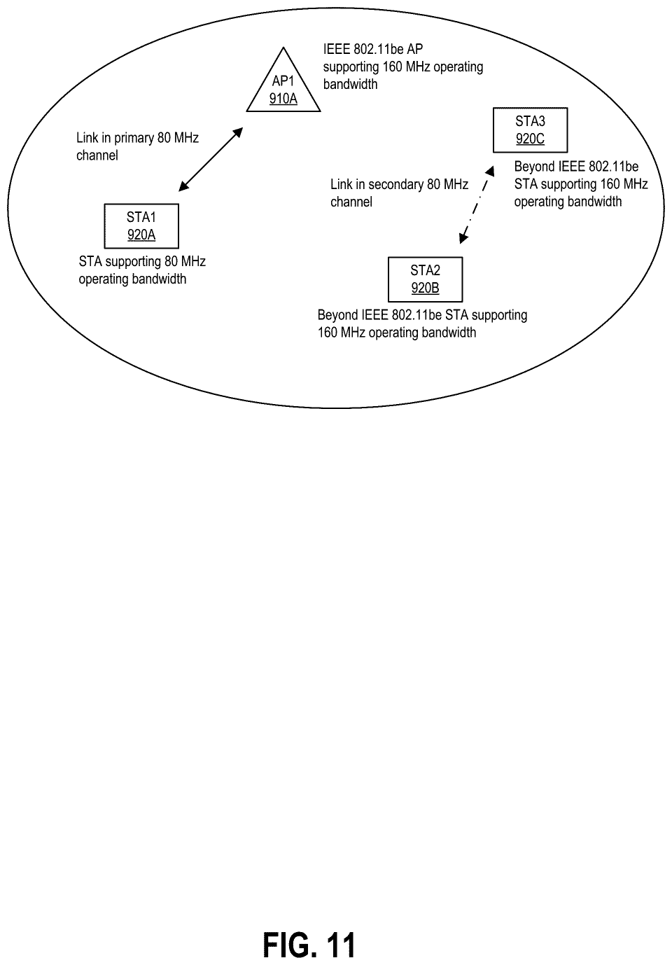

FIG. 11 is a diagram showing a non-primary channel access in the single BSS scenario, according to some embodiments.

The scenario shown in the diagram is similar to the scenario shown in FIG. 9 and described in relation thereto, but shows that STA2 920B and STA3 920C may communicate over a link in the secondary 80 MHz channel during the TXOP in BSS1 in the primary 80 MHZ channel. In particular, STA2 920B and STA3 920C may recognize that the maximum supportable bandwidth of the TXOP in BSS1 (80 MHZ) is less than its own maximum supportable bandwidth of 160 MHz, which means that there may be idle bandwidth available during the TXOP. Based on such recognition, STA2 920B and STA3 920C may directly communicate with each other over a link in the secondary 80 MHz channel during the TXOP.

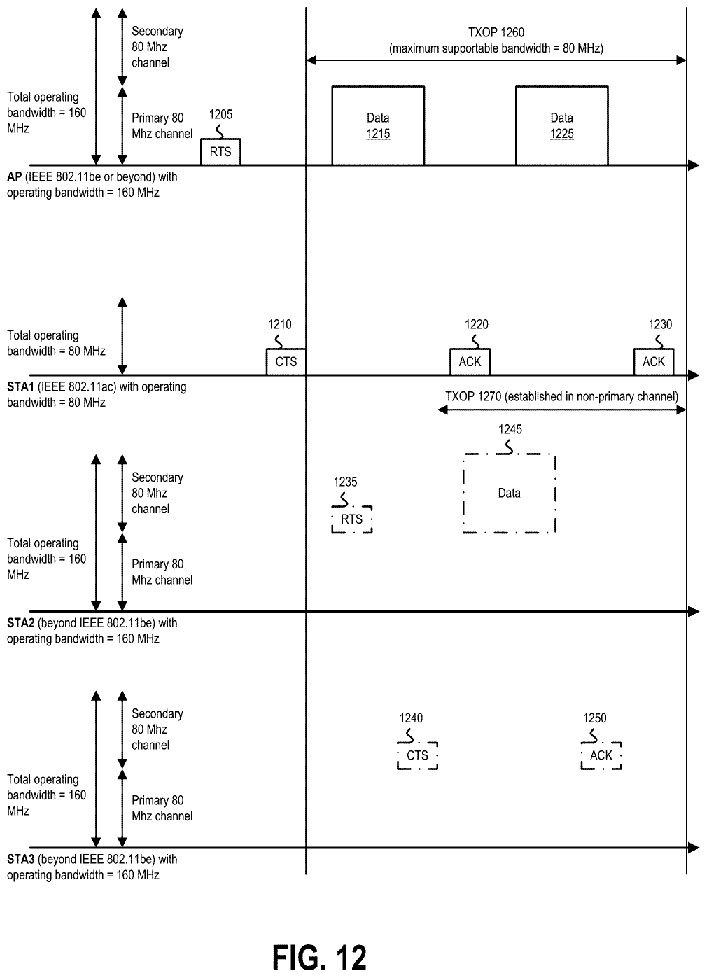

FIG. 12 is a diagram showing a frame exchange sequence for accessing a non-primary channel, according to some embodiments.

The frame exchange sequence assumes a scenario similar to the single BSS scenario shown in FIG. 11. It should be appreciated, however, that a similar frame exchange sequence can be used for accessing a non-primary channel in the OBSS scenario mentioned above. The frame exchange sequence may involve an AP that supports an operating bandwidth of 160 MHZ (e.g., an IEEE 802.11be or beyond AP), a first STA (STA1) that supports an operating bandwidth of 80 MHz (e.g., an IEEE 802.11ac STA), a second STA (STA2) that supports an operating bandwidth of 160 MHz (e.g., a beyond IEEE 802.11be STA), and a third STA (STA3) that supports an operating bandwidth of 160 MHZ (e.g., a beyond IEEE 802.11be STA). A 160 MHz operating bandwidth may include a primary 80 MHz channel and a secondary 80 MHZ channel.

As shown in the diagram, the AP may transmit request-to-send (RTS) frame 1205 to STA1 in the primary 80 MHz channel and STA 1 may respond by transmitting clear-to-send (CTS) frame 1210 to the AP in the primary 80 MHz channel. The RTS and CTS frame exchange between the AP and STA1 may establish TXOP 1260 in the primary 80 MHz channel. Since STA1 only has an operating bandwidth of 80 MHz, the maximum supportable bandwidth of the TXOP 1260 is 80 MHz. During TXOP 1260, the AP may transmit data frame 1215 to STA1 in the primary 80 MHz channel and STA1 may respond by transmitting ACK frame 1220 to the AP in the primary 80 MHz channel. Also, during TXOP 1260, the AP may transmit another data frame 1225 to STA1 in the primary 80 MHz channel and STA1 may respond by transmitting ACK frame 1230 to the AP in the primary 80 MHz channel.

If STA2 and STA3 know that the maximum supportable bandwidth of TXOP 1260 is 80 MHz (e.g., because STA1's operating bandwidth is 80 MHz), STA2 and STA3 may set their NAV only in the primary 80 MHz channel and establish a P2P link in the secondary 80 MHz channel. During TXOP 1260, STA2 may transmit RTS frame 1235 to STA3 in the secondary 80 MHz channel and STA3 may respond by transmitting CTS frame 140 to STA2 in the secondary 80 MHz channel. The RTS and CTS frame exchange between STA2 and STA3 may establish TXOP 1270 in the secondary 80 MHz channel. TXOP 1260 established in the primary channel (e.g., primary 80 MHz channel) may be referred to as a primary TXOP and TXOP 1270 established in the non-primary channel (e.g., secondary 80 MHz channel) may be referred to as a secondary TXOP. During secondary TXOP 1270, STA2 may transmit data frame 1245 to STA3 in the secondary 80 MHz channel and STA3 may respond by transmitting ACK frame 1250 to STA2 in the secondary 80 MHz channel. The duration of secondary TXOP 1270 may not exceed the end of primary TXOP 1260 in the primary 80 MHz channel.

In an embodiment, an AP/STA may determine the maximum supportable bandwidth of another AP/STA based on capability information and/or protocol version information advertised by that AP/STA (e.g., an AP/STA that advertises that it supports IEEE 802.11ac may indicate that the AP/STA has a maximum supportable bandwidth of 80 MHz, an AP/STA that advertises that it supports IEEE 802.11ax may indicate that the AP/STA has a maximum supportable bandwidth of 160 MHz, and so on). The AP/STA may determine the maximum supportable bandwidth of a TXOP based on the maximum supportable bandwidths of the AP/STAs involved in the TXOP. For example, the maximum supportable bandwidth of the TXOP may be the smallest maximum supportable bandwidth among the APs/STAs involved in the TXOP.

In the example frame exchange sequence, the TXOP is established using a RTS and CTS frame exchange. In embodiments, a TXOP is established using a trigger frame transmission instead. In such an embodiment, the trigger frame may include bandwidth information for the triggered transmission and other APs/STAs may determine the maximum supportable bandwidth of the TXOP based on the bandwidth information included in the trigger frame. In an embodiment, the trigger frame is a multi-user request-to-send (MU-RTS) frame or similar trigger frame.

In an embodiment, the same clear channel assessment (CCA) threshold and same distributed coordination function interframe space (DIFS) is used in the primary channel and the non-primary channel. In an embodiment, a different CCA threshold and/or different DIFS is used in the primary channel and the non-primary channel. For example, to give lower priority to non-primary channel access compared to primary channel access, a more stringent channel sensing rule may be applied in the non-primary channel by decreasing the CCA threshold. Additionally or alternatively, a secondary DIFS that is longer than the regular DIFS can be defined and used in the non-primary channel to give lower to give lower priority to non-primary channel access.

With embodiments, APs/STAs can determine when a non-primary channel will be idle during a TXOP and access the non-primary channel during the TXOP, which allows for achieving higher spectrum utilization in the wireless network.

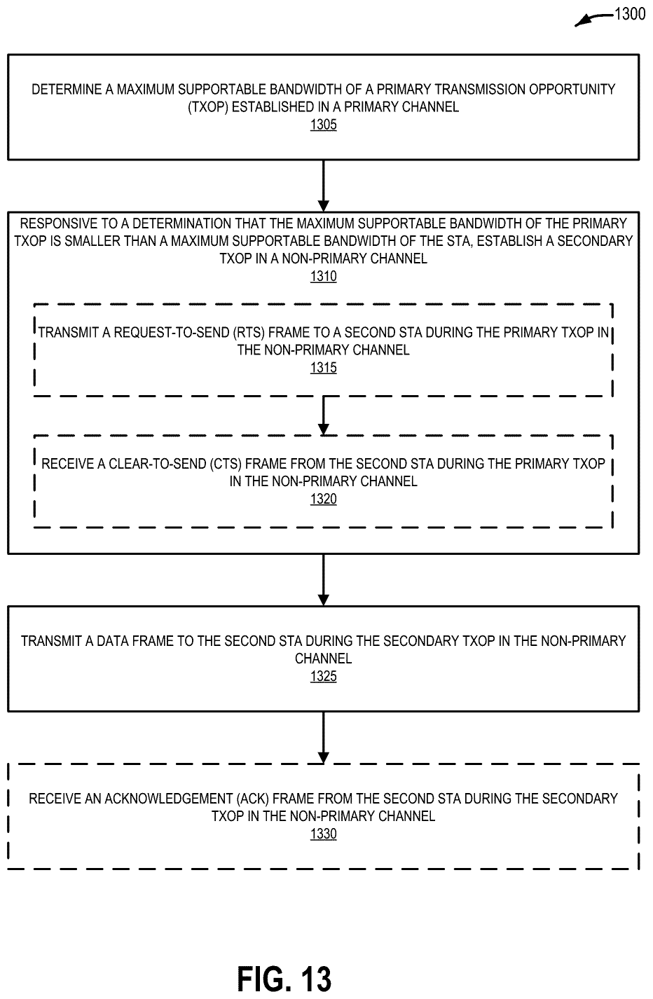

Turning now to FIG. 13, a method 1100 will be described for accessing a non-primary channel, in accordance with an example embodiment. The method 1300 may be performed by a STA (an AP STA or a non-AP STA) implemented by a wireless device (e.g., wireless device 104).

Additionally, although shown in a particular order, in some embodiments the operations of the method 1300 (and the other methods shown in the other figures) may be performed in a different order. For example, although the operations of the method 1300 are shown in a sequential order, some of the operations may be performed in partially or entirely overlapping time periods.

In an embodiment, at operation 1305, the STA determines a maximum supportable bandwidth of a primary TXOP established in a primary channel. In an embodiment, the maximum supportable bandwidth of the primary TXOP is determined based on capability information or protocol version information advertised by one or more STAs involved in the primary TXOP. In an embodiment, the primary TXOP is established based on a RTS frame and CTS frame exchange between STAs involved in the primary TXOP. In an embodiment, the primary TXOP is established based on a transmission of a trigger frame by an AP involved in the primary TXOP. In an embodiment, the trigger frame is a MU-RTS frame. In such an embodiment, the maximum supportable bandwidth of the primary TXOP may be determined based on bandwidth information included in the trigger frame.

At operation 1310, responsive to a determination that the maximum supportable bandwidth of the primary TXOP is smaller than a maximum supportable bandwidth of the STA, the STA establishes a secondary TXOP in the non-primary channel. In an embodiment, establishing the secondary TXOP in the non-primary channel involves operations 1315 and 1320. At operation 1310, the STA transmits a RTS frame to a second STA during the primary TXOP in the non-primary channel. At operation 1315, the STA receives a CTS frame from the second STA during the primary TXOP in the non-primary channel. In an embodiment, responsive to the determination that the maximum supportable bandwidth of the primary TXOP is smaller than the maximum supportable bandwidth of the STA, the STA sets a NAV in the primary channel that lasts for a remainder of the primary TXOP.

In an embodiment, the maximum supportable bandwidth of the primary TXOP is 80 MHz and the maximum supportable bandwidth of the STA is 160 MHZ. In an embodiment, the primary channel is a primary 80 MHz channel that includes a primary 20 MHz channel and the non-primary channel is a secondary 80 MHz channel that does not include the primary 20 MHZ channel.

At operation 1325, the STA transmits a data frame to the second STA during the secondary TXOP in the non-primary channel. In an embodiment, a same CCA threshold and/or a same DIFS are used in the primary channel and the non-primary channel. In an embodiment, a lower CCA threshold is used in the non-primary channel compared to the primary channel and a secondary DIFS is used in the non-primary channel that is longer compared to a DIFS used in the primary channel. In an embodiment, the STA and the second STA are non-AP STAs (e.g., and the data frame transmission is over a P2P link between the STA and the second STA). In an embodiment, the STA is an AP STA and the second STA is a non-AP STA (e.g., and the AP STA serves a BSS that is different from the BSS in which the primary TXOP is established).

In an embodiment, at operation 1330, the STA receives an ACK frame from the second STA during the secondary TXOP in the non-primary channel.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a station (STA) implemented by a wireless device to access a non-primary channel, the method comprising:
determining a maximum supportable bandwidth of a primary transmission opportunity (TXOP) established in a primary channel;
responsive to a determination that the maximum supportable bandwidth of the primary TXOP is smaller than a maximum supportable bandwidth of the STA, establishing a secondary TXOP in the non-primary channel; and
transmitting a data frame to a second STA during the secondary TXOP in the non-primary channel.

2. The method of claim 1, wherein the maximum supportable bandwidth of the primary TXOP is determined based on capability information or protocol version information advertised by one or more STAs involved in the primary TXOP.

3. The method of claim 1, wherein the primary TXOP is established based on a request-to-send (RTS) frame and clear-to-send (CTS) frame exchange between STAs involved in the primary TXOP.

4. The method of claim 1, wherein the primary TXOP is established based on a transmission of a trigger frame by an access point (AP) involved in the primary TXOP.

5. The method of claim 4, wherein the trigger frame is a multi-user request-to-send (MU-RTS) frame.

6. The method of claim 4, wherein the maximum supportable bandwidth of the primary TXOP is determined based on bandwidth information included in the trigger frame.

7. The method of claim 1, wherein a same clear channel assessment (CCA) threshold and a same distributed coordination function interframe space (DIFS) are used in the primary channel and the non-primary channel.

8. The method of claim 1, wherein a lower clear channel assessment (CCA) threshold is used in the non-primary channel compared to the primary channel and a secondary DIFS is used in the non-primary channel that is longer compared to a DIFS used in the primary channel.

9. The method of claim 1, wherein the maximum supportable bandwidth of the primary TXOP is 80 Megahertz (MHz) and the maximum supportable bandwidth of the STA is 160 MHz.

10. The method of claim 9, wherein the primary channel is a primary 80 MHz channel that includes a primary 20 MHz channel and the non-primary channel is a secondary 80 MHz channel that does not include the primary 20 MHz channel.

11. The method of claim 1, wherein establishing the secondary TXOP in the non-primary channel comprises:
transmitting a request-to-send (RTS) frame to the second STA during the primary TXOP in the non-primary channel; and
receiving a clear-to-send (CTS) frame from the second STA during the primary TXOP in the non-primary channel.

12. The method of claim 1, further comprising:
responsive to the determination that the maximum supportable bandwidth of the primary TXOP is smaller than the maximum supportable bandwidth of the STA, setting a network allocation vector (NAV) in the primary channel that lasts for a remainder of the primary TXOP.

13. The method of claim 1, wherein the STA and the second STA are non-AP STAs.

14. The method of claim 1, wherein the STA is an AP STA and the second STA is a non-AP STA.

15. A wireless device to implement a station (STA) in a wireless network, the wireless device comprising:
a radio frequency transceiver;
a memory device storing a set of instructions; and
a processor coupled to the memory device, wherein the set of instructions when executed by the processor causes the STA to:
determine a maximum supportable bandwidth of a primary transmission opportunity (TXOP) established in a primary channel;
responsive to a determination that the maximum supportable bandwidth of the primary TXOP is smaller than a maximum supportable bandwidth of the STA, establish a secondary TXOP in a non-primary channel; and
transmit a data frame to a second STA during the secondary TXOP in the non-primary channel.

16. The wireless device of claim 15, wherein the maximum supportable bandwidth of the primary TXOP is determined based on capability information or protocol version information advertised by one or more STAs involved in the primary TXOP.

17. The wireless device of claim 15, wherein the primary TXOP is established based on a request-to-send (RTS) frame and clear-to-send (CTS) frame exchange between STAs involved in the primary TXOP.

18. A non-transitory machine-readable storage medium having stored therein instructions, which when executed by a wireless device implementing a station (STA) in a wireless network cause the STA to perform operations comprising:
determining a maximum supportable bandwidth of a primary transmission opportunity (TXOP) established in a primary channel;
responsive to a determination that the maximum supportable bandwidth of the primary TXOP is smaller than a maximum supportable bandwidth of the STA, establishing a secondary TXOP in a non-primary channel; and
transmitting a data frame to a second STA during the secondary TXOP in the non-primary channel.

19. The non-transitory machine-readable storage medium of claim 18, wherein the primary TXOP is established based on a transmission of a trigger frame by an access point (AP) involved in the primary TXOP.

20. The non-transitory machine-readable storage medium of claim 19, wherein the trigger frame is a multi-user request-to-send (MU-RTS) frame.
